(19) United States
(12) Patent Application Publication
(10) Pub. No.: US 2016/0350231 A1
(43) Pub. Date: Dec. 1, 2016

(54) MAGNETIC DISK DEVICE AND METHOD FOR EXECUTING SYNCHRONIZE COMMAND

(71) Applicant: Kabushiki Kaisha Toshiba, Tokyo (JP)

(72) Inventors: Michihiko Umeda, Yokohama Kanagawa (JP); Yusuke Izumizawa, Yokohama Kanagawa (JP); Nobuhiro Sugawara, Yokohama Kanagawa (JP); Hidekazu Masuyama, Kawasaki Kanagawa (JP)

(21) Appl. No.: 14/836,675

(22) Filed: Aug. 26, 2015

Related U.S. Application Data
(60) Provisional application No. 62/169,163, filed on Jun. 1, 2015.

(51) Int. Cl. G06F 12/08; G06F 3/06

(52) U.S. Cl. CPC G06F 12/0891; G06F 3/0629; G06F 3/0604; G06F 3/0685; G06F 2212/21; G06F 2212/22

(57) ABSTRACT

According to one embodiment, a magnetic disk device includes a disk, a volatile memory, and a controller. The disk includes a save area and a user data area. The volatile memory includes a cache area and a cache management area. The cache area is used to store, as write cache data, write data specified by a write command to be written to the user data area. The cache management area is used to store management records for the write cache data. The controller writes write cache data indicated by the management record and not having been written to the user data area, to the save area in accordance with a synchronize command.

### CROSS-REFERENCE TO RELATED APPLICATIONS

This application claims the benefit of U.S. Provisional Application No. 62/169,163, filed Jun. 1, 2015, the entire contents of which are incorporated herein by reference.

### FIELD

Embodiments described herein relate generally to a magnetic disk device and a method for executing a synchronize command.

### BACKGROUND

Recent magnetic disk devices comprise, for example, a cache buffer referred to as a disk cache to accelerate access from a host system (host) to the magnetic disk device. The cache buffer is used to store data specified by a write command from the host (write data) and data read from a disk in accordance with a read command from the host.

A controller for such a magnetic disk device reports a status related to the write command to the host in response to storing of the write data (write cache data) in the cache buffer. The controller performs a disk write operation to the disk using the write cache data (what is called a write-back operation), asynchronously with execution of the write command. Consequently, in general, write cache data that has not been written to (reflected in) the disk is present in the cache buffer.

Thus, recent hosts can issue a synchronize command for forcibly writing such write cache data to the disk, to the controller. The controller executes a process designated by the synchronize command (synchronize command process) in response to reception of the synchronize command. However, if, for example, a large number of write cache data that need to be randomly accessed are present in the cache buffer, the synchronize command process needs a long time. In this case, completion of execution of the synchronize command is delayed. Thus, there has been a demand to reduce the amount of time needed for the synchronize command process.

### BRIEF DESCRIPTION OF THE DRAWINGS

FIG. 1 is a block diagram showing an exemplary configuration of a magnetic disk device according to an embodiment;

FIG. 2 is a flowchart illustrating an exemplary procedure for a synchronize command process in the embodiment;

FIG. 3 is a diagram illustrating the synchronize command process;

FIG. 4 is a flowchart illustrating an exemplary procedure for a write-back process executed cache management record by cache management record in the embodiment;

FIG. 5 is a flowchart illustrating an exemplary procedure for a write command process in the embodiment;

FIG. 6 is a flowchart illustrating an exemplary procedure for a read command process in the embodiment; and

FIG. 7 is a flowchart illustrating an exemplary procedure for a process accompanying power-on in the embodiment.

### DETAILED DESCRIPTION

Various embodiments will be described hereinafter with reference to the accompanying drawings.

In general, according to one embodiment, a magnetic disk device includes a disk, a volatile memory, and a controller. The disk includes a save area and a user data area. The volatile memory includes a cache area and a cache management area. The cache area is used to store, as write cache data, write data specified by a write command to be written to the user data area. The cache management area is used to store management records for the write cache data. The controller writes write cache data indicated by the management record and not having been written to the user data area, to the save area in accordance with a synchronize command.

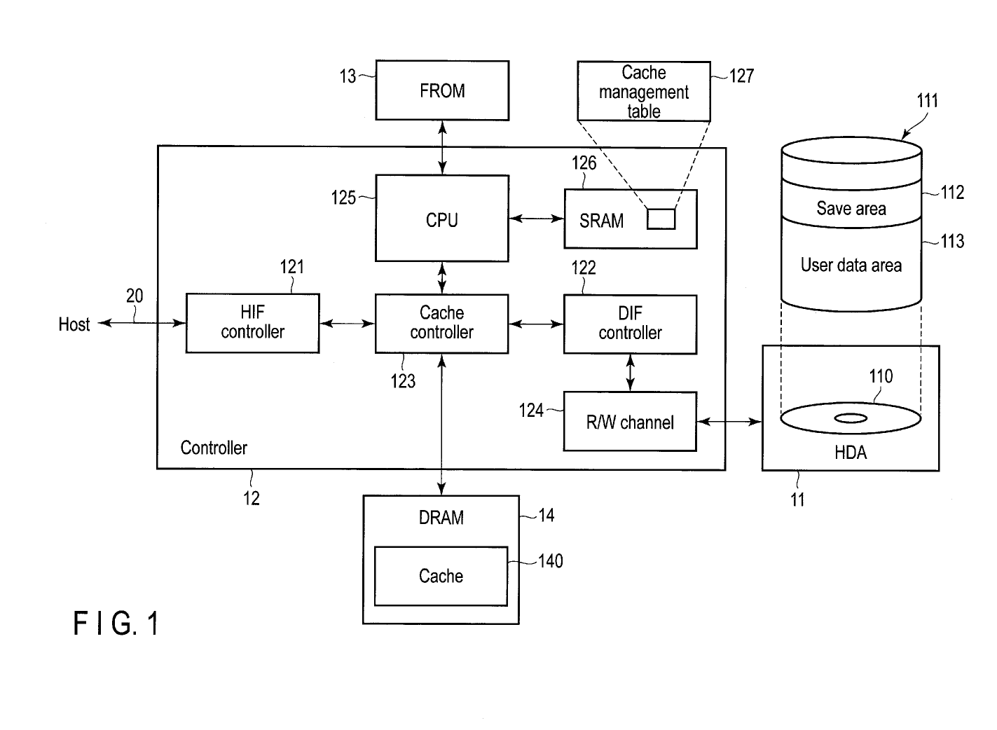

FIG. 1 is a block diagram showing an exemplary configuration of a magnetic disk device according to an embodiment. The magnetic disk device is also referred to as a hard disk drive (HDD). Thus, the magnetic disk device is hereinafter referred to as the HDD. The HDD shown in FIG. 1 includes a head disk assembly (HDA) 11, a controller 12, a flash ROM (FROM) 13, and a dynamic RAM (DRAM) 14.

The HDA 11 includes a disk 110. The disk 110 is, for example, a recording medium including, on one surface, a recording surface on which data is magnetically recorded. In other words, the disk 110 includes a storage area 111. The HDA 11 further includes well-known elements such as a head, a spindle motor, and an actuator. However, these elements are omitted from FIG. 1.

The controller 12 is implemented using, for example, a large-scale integrated circuit (LSI) referred to as a system-on-a-chip (SOC) and including a plurality of elements integrated together on a single chip. The controller 12 includes a host interface controller (hereinafter referred to as an HIF controller) 121, a disk interface controller (DIF controller) 122, a cache controller 123, a read/write (R/W) channel 124, a CPU 125, and a static RAM (SRAM) 126.

The HIF controller 121 is connected to a host via a host interface 20. The HIF controller 121 receives commands (a write command, a read command, and the like) transferred from the host. The HIF controller 121 also controls data transfer between the host and the cache controller 123.

The DIF controller 122 controls data transfer between the cache controller 123 and the R/W channel 124. The cache controller 123 controls data transfer between the HIF controller 121 and the DRAM 14 and data transfer between the DIF controller 122 and the DRAM 14.

The R/W channel 124 processes signals for read and write. The R/W channel 124 converts a readout signal (read signal) into digital data using an analog-to-digital converter, and decodes read data from the digital data. The R/W channel 124 also extracts servo data needed to position a head, from the digital data. The R/W channel 124 also codes write data.

The CPU 125 functions as a main controller for the HDD shown in FIG. 1. The CPU 125 controls at least some of the elements in the HDD in accordance with a control program. The at least some elements include the controllers 121 to 123. In the embodiment, the control program is prestored in a particular area of the disk 110. However, the control program may be prestored in the FROM 13.

The SRAM 126 is a volatile memory. A part of a storage area in the SRAM 126 is used as a cache management area in which a cache management table 127 is stored.

The FROM 13 is a rewritable nonvolatile memory. An initial program loader (IPL) is stored in a part of a storage area in the FROM 13. By, for example, executing the IPL after power is supplied to the HDD, the CPU 125 loads at least a part of the control program stored on the disk 110 into the SRAM 126 or the DRAM 14.

The DRAM 14 is a volatile memory that operates at a lower speed than the SRAM 126. In the embodiment, the DRAM 14 has a larger capacity than that of the SRAM 126. A part of the storage area of the DRAM 14 is used as a cache area, in other words, as a cache buffer (hereinafter referred to as a cache) 140. The cache 140 is used to store write data transferred from the host and read data read from the disk 110, as write cache data and read cache data, respectively.

Another part of the storage area may be used for the cache management table 127. Similarly, part of the storage area in the SRAM 126 may be used as the cache 140. The storage area in each of the DRAM 14 and SRAM 126 may be considered to be a part of the storage area in one volatile memory.

A part of the storage area 111 in the disk 110 is used as a save area 112, and another part of the storage area 111 is used as a user data area 113. The save area 112 is, for example, a part of a system area not allowed to be accessed by a user, and is used as a destination to which write cache data in the cache 140 is saved. The user data area 113 is used to store write data specified by a write command from the host. An address indicative of a physical position in the user data area 113 in which the write data is stored (in other words, a physical address) is associated with a logical address specified by the write command (more specifically, a logical block address LBA).

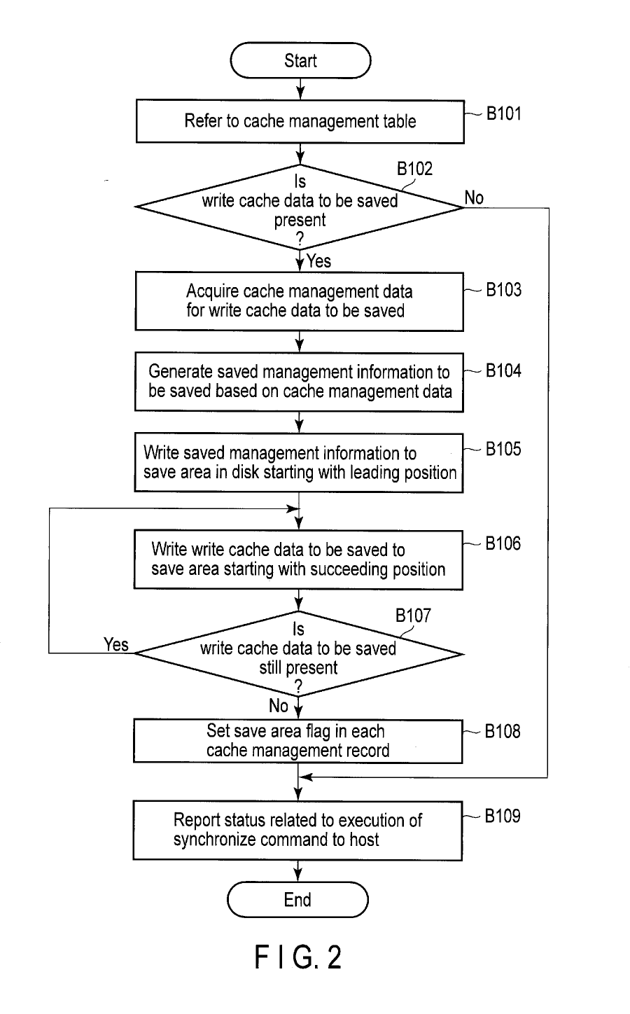

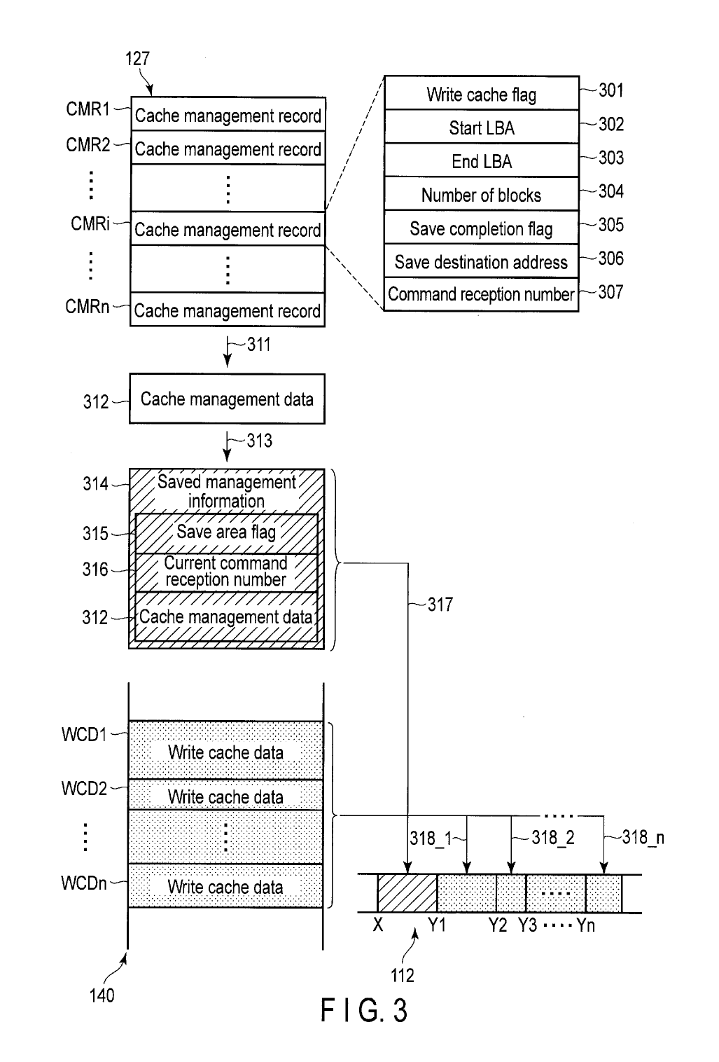

Now, a synchronize command process in the embodiment will be described with reference to FIG. 2 and FIG. 3. FIG. 2 is a flowchart illustrating an exemplary procedure for the synchronize command process. FIG. 3 is a diagram illustrating the synchronize command process.

First, it is assumed that a synchronize command is sent via the host interface 20 from the host to the HDD shown in FIG. 1. The synchronize command forces writing of write cache data in the cache 140 (for example, the write cache data not having been written to the disk 110) to the disk 110. In the embodiment, the host interface 20 is a Small Computer System Interface (SCSI). In this case, a synchronize cache command is used as the synchronize command. The host interface 20 may be an interface other than the SCSI. As the synchronize command, a flush cache command may be used depending on the type of host interface 20.

The synchronize command sent from the host to the HDD is received by the HIF controller 121. The received synchronize command is passed to the CPU 125. Then, the CPU 125 cooperates with the DIF controller 122 and the cache controller 123 in executing the synchronize command process as follows.

First, the CPU 125 refers to the cache management table 127 (B101). The cache management table 127 is used to hold cache management records. In the example illustrated in FIG. 3, cache management records CMR1 to CMRn including a cache management record CMRi are held in n entries in the cache management table 127. To simplify description, it is assumed that all of cache management records CMR1 to CMRn have been generated in accordance with write commands WCMD1 to WCMDn from the host. In other words, cache management records CMR1 to CMRn are assumed to be used to manage write cache data WCD1 to WCDn stored in the cache 140.

Cache management record CMRi includes fields 301 to 307. Field 301 is used to hold a write cache flag. In a valid status, the write cache flag indicates that write cache data WCDi is to be written to a location on (the user data area 113 in) the disk 110 where write cache data WCDi is originally to be stored (the location is hereinafter referred to as the regular location). When cache management record CMRi is stored in the cache management table 127, the valid write cache flag has been set in field 301. The address (physical address) of the regular location is associated, by a conventional address translation table, with a logical write range specified by a start LBA and the number of blocks (m) contained in a write command WCMDi. In other words, the regular location is indirectly specified by write command WCMDi. An end LBA of the logical write range is calculated by calculating Start LBA+m−1.

Fields 302, 303, and 304 are used to hold the start LBA, the end LBA, and the number of blocks, respectively. One of fields 303 and 304 may be omitted from cache management record CMRi.

Field 305 is used to hold a save completion flag. In a valid status, the save completion flag indicates that all of the write cache data present when the synchronize command is received (for example, write cache data WCD1 to WCDn) have been saved to the save area 112. When cache management record CMRi is stored in the cache management table 127, the valid save completion flag has not been set in field 305.

Field 306 is used to hold the address (physical address) of the location in the save area 112 where write cache data WCDi has been saved, in other words, a save destination address. At the time when cache management record CMRi is stored in the cache management table 127, the save destination address has not been set in field 306. Field 307 is used to hold a command reception number assigned to write command WCMDi. The command reception number is incremented in response to generation of a cache management record.

The structure of each of cache management records CMR1 to CMRn except cache management record CMRi is similar to the structure of cache management record CMRi. In other words, each of cache management records CMR1 to CMRn includes fields 301 to 307.

The embodiment assumes that write commands WCMD1 to WCMDn have been received in this order. In other words, the order of the command reception numbers in cache management records CMR1 to CMRn matches the reception order of write commands WCMD1 to WCMDn.

A field for cache pointer data is omitted from cache management record CMRi shown in FIG. 3. The cache pointer data is indicative of a location in the cache 140 in which write cache data WCDi is stored.

As seen again in the flowchart in FIG. 2, the CPU 125 determines whether write cache data to be saved is present in the save area 112 is determined based on referring to (B101) to the cache management table 127 (B102). When a cache management record is present in which the write cache flag has been set but in which the save completion flag has not been set (hereinafter referred to as a target cache management record), the CPU 125 determines that write cache data to be saved to the save area 112 is present (Yes in B102). In the embodiment, cache management records CMR1 to CMRn shown in FIG. 3 are detected as target cache management records.

In this case, the CPU 125 acquires (generates), based on all of (target) cache management records CMR1 to CMRn as shown by arrow 311 in FIG. 3, cache management data 312 on the write cache data to be saved (B103). The cache management data 312 includes, for example, the contents of fields 301 to 307 of respective cache management records CMR1 to CMRn as elements corresponding to the respective cache management records CMR1 to CMRn, respectively.

To acquire the cache management data 312, the CPU 125 sorts cache management records CMR1 to CMRn in ascending order of command reception numbers. Consequently, the order of the elements corresponding to cache management records CMR1 to CMRn in the cache management data 312 matches the order of the command reception numbers.

The CPU 125 determines addresses Y1 to Yn to which write cache data WCD1 to WCDn are saved. The save destination addresses Y1 to Yn are each determined by the length of saved management information 314 described below and the length of each of write cache data WCD1 to WCDn. The length of the saved management information 314 is determined based on the length of the cache management data 312. The length of each of write cache data WCD1 to WCDn is determined by the start LBA and end LBA (or the number of blocks) contained in each of cache management records CMR1 to CMRn.

The determined save destination addresses Y1 to Yn are set in fields 306 of the respective cache management records CMR1 to CMRn in the cache management table 127 and in fields 306 of the elements in the cache management data 312 which correspond to the respective cache management records CMR1 to CMRn. The CPU 125 may acquire the cache management data 312 after setting the save destination addresses Y1 to Yn in fields 306 of the respective cache management records CMR1 to CMRn in the cache management table 127. Furthermore, the contents of fields 306 of the respective cache management records CMR1 to CMRn may be omitted from the cache management data 312.

Then, the CPU 125 generates saved management information 314 based on the cache management data 312 as shown by arrow 313 in FIG. 3 (B104). The saved management information 314 includes, in addition to the cache management data 312, fields 315 and 316 in which a (valid) save area flag and a (valid) current command reception number, respectively, have been set as shown in FIG. 3. Therefore, the length of the saved management information 314 is equal to a length resulting from addition of the length of fields 315 and 316 to the length of the cache management data 312.

In a valid status, the save area flag indicates that data in the save area 112 in the disk 110 is valid. The current command reception number is indicative of the latest command reception number at the time of the start of the synchronize command process. In the embodiment, the current command reception number matches the command reception number in cache management record CMRn.

Then, the CPU 125 requests the cache controller 123 to save the saved management information 314. Then, the cache controller 123 (in corporation with the DIF controller 122) writes the saved management information 314 starting with a leading position X in the save area 112 as shown by arrow 317 in FIG. 3 (B105). In this regard, it is assumed that the saved management information 314 has been written to a location from position X to position Y1 in the save area 112 as shown in FIG. 3.

Then, the cache controller 123 writes write cache data WCD1 in the cache 140 associated with the oldest command reception number, to a location from position Y1 to position Y2 in the save area 112 as shown by arrow 318_1 in FIG. 3 (B106). Then, the cache controller 123 determines whether write cache data to be saved is still present (B107).

If write cache data to be saved is still present as in the example in FIG. 3 (Yes in B107), the cache controller 123 writes write cache data WCD2 in the cache 140 associated with the second oldest command reception number to a location from position Y2 to position Y3 in the save area 112 as shown by arrow 318_2 in FIG. 3 (B106).

As described above, the cache controller 123 writes the saved management information 314 and then sequentially writes write cache data WCD1 to WCDn into the save area 112. Consequently, in the synchronize command process in accordance with the synchronize command from the host, the cache controller 123 can quickly save write cache data WCD1 to WCDn to the disk 110. In other words, the synchronize command process can be executed in a short time. Thus, power supplied to the HDD is unlikely to be suddenly shut down during the synchronize command process, and even if the HDD is not provided with any backup power supply, the content of the write cache present at the time of the reception of the synchronize command can be secured.

In contrast, it is assumed that, in the synchronize command process, write cache data WCD1 to WCDn are written to the regular location in the user data area 113 in the disk 110 unlike in the embodiment. In this case, random access of write cache data WCD1 to WCDn occurs, leading to the need of a long time for the synchronize command process. This tendency is more significant when, for example, the cache 140 has an increased capacity and contains a large number of write cache data that need to be randomly accessed. In this case, power supplied to the HDD is likely to be suddenly shut down during the synchronize command process, and if the HDD is not provided with any backup power supply, the content of the write cache present at the time of the reception of the synchronize command is difficult to secure.

It is assumed that, as a result of saving of all of write cache data WCD1 to WCDn, the determination in B107 is No. In this case, the cache controller 123 notifies the CPU 125 of completion of a save operation in accordance with the synchronize command.

Then, the CPU 125 sets the save completion flag in each of fields 305 of cache management records CMR1 to CMRn in the cache management table 127 (B108). The CPU 125 then proceeds to B109. On the other hand, when the determination in B102 described above is No, the CPU 125 skips B103 to B108 to proceed to B109. In B109, the CPU 125 allows the HIF controller 121 to report a status related to execution of the synchronize command to the host. Consequently, the CPU 125 ends the synchronize command process.

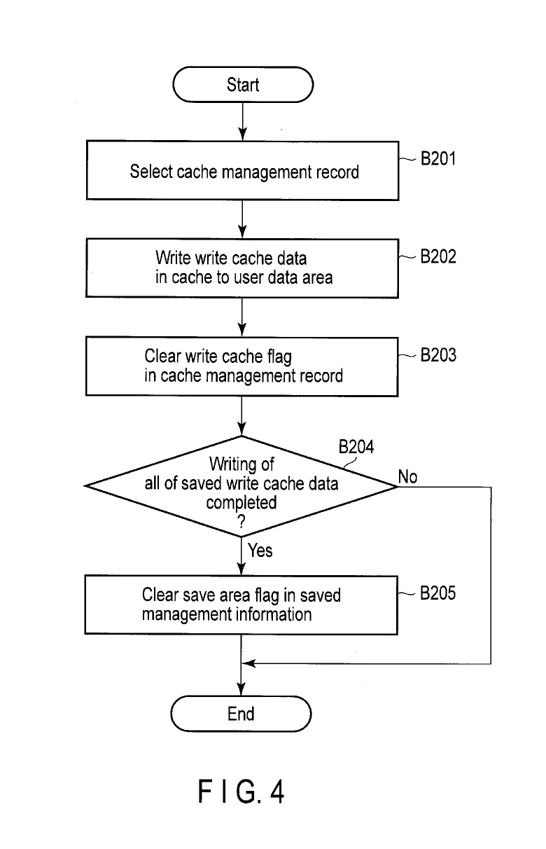

Now, a write-back process according to the embodiment will be described with reference to FIG. 4. FIG. 4 is a flowchart illustrating an exemplary procedure for a write-back process executed cache management record by cache management record. The write-back process in the embodiment refers to a process for writing write cache data saved to the save area 112 to the regular location in the user data area 113. The write-back process is repeatedly executed at any timings cache management record by cache management record, for example, after reporting of the status related to the execution of the synchronize command.

First, the CPU 125 selects one of cache management records CMR1 to CMRn in the cache management table 127 that is related to the write cache data to be written to the user data area 113 (B201). Candidates in B201 are those of cache management records CMR1 to CMRn in which the write cache flags have been set.

The B201 will be described below in detail. It is assumed that the write cache flags have been set in all of cache management records CMR1 to CMRn. In this case, the CPU 125 compares the command reception numbers in cache management records CMR1 to CMRn with one another, and thus selects, for example, the cache management record with the oldest (smallest) command reception number. In other words, for each write-back process, of the cache management records in which the write cache flags have been set at that point in time, the CPU 125 selects one in which contains the oldest command reception number.

As described above, in the embodiment, cache management records CMR1 to CMRn are selected in order of the command reception numbers. Thus, update of new write cache data (write data) with old write cache data can be prevented when write ranges indicated by a plurality of cache management records overlap.

Cache management records having non-overlapping write ranges may be selected regardless of the command reception numbers. For example, such cache management records may be selected in order in which the write ranges indicated by the cache management records can be optimally accessed. The order in which the write ranges can be optimally accessed refers to, for example, the order in which an amount of time needed for seek operations and latency resulting from switching of the write ranges is minimized.

It is assumed that, in B201, cache management record CMRi is selected. In this case, the CPU 125 writes write cache data WCDi in the cache 140 managed by cache management records CMRi, to the regular location in the user data area 113 (B202). This operation (in other words, a write-back operation) is performed through cooperation with the cache controller 123 and the DIF controller 122.

Then, the CPU 125 clears the write cache flag in cache management record CMRi (B203). The CPU 125 then determines whether the write, to the user data area 113, of all of write cache data WCD1 to WCDn saved to the save area 112 has been completed (B204). When selection from the cache management records is performed based on the order of the command reception number as in the embodiment, the CPU 125 determines that the writing of all write cache data WCD1 to WCDn to the user data area 113 is completed at the time when cache data WCDn has been written to the user data area 113. The CPU 125 may execute the determination based on whether the write cache flags have been cleared in all of cache management records CMR1 to CMRn.

If the determination in B204 is Yes, the write cache data in the save area 112 is not needed. In this case, in order to invalidate the write cache data in the save area 112, the CPU 125 clears a save area flag in saved management information 314 written to the save area 112 (B205). The CPU 125 then ends the write-back process. In contrast, when the determination in B205 is No, the CPU 125 skips B205 to end the write-back process.

It is assumed that before the writing of all the saved write cache data to the user data area 113 is completed, the HIF controller 121 receives a new synchronize command from the host. In this case, the CPU 125 selects all of those of the cache management records currently stored in the cache management table 127 which are related to write cache data that have not been saved to the save area 112. In other words, the CPU 125 selects all of the cache management records stored in the cache management table 127 during a period from a point in time when the preceding synchronize command is received until a point in time when a new synchronize command is received.

Then, the CPU 125 generates new cache management data corresponding to the above-described cache management data 312 based on the selected cache management record. The CPU 125 sequentially writes the new cache management data and the write cache data indicated by the selected cache management record, in the save area 112 starting at a position succeeding the location where write cache data WCDn has been saved.

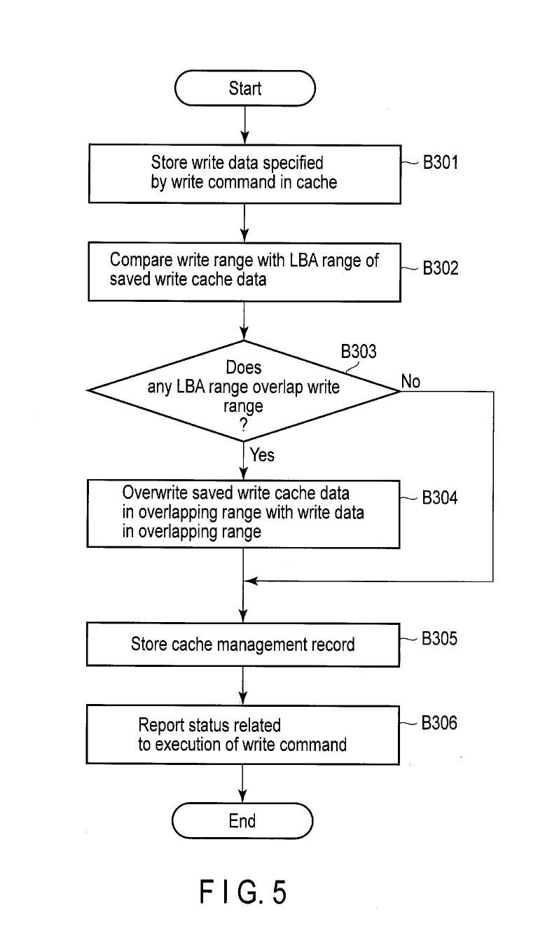

Now, a write command process in the embodiment will be described with reference to FIG. 5. FIG. 5 is a flowchart illustrating an exemplary procedure for the write command process. It is assumed that the HIF controller 121 receives a write command WCMD sent from the host to the HDD and passes the write command WCMD to the CPU 125. It is assumed that, at this time, the write, to the user data area 113, of the write cache data saved to the save area 112 has not been completed. In other words, the save area flag has been set in the saved management information 314 stored in the save area 112.

In accordance with the write command WCMD, the CPU 125 executes the write command process as follows. First, the CPU 125 requests the cache controller 123 to cache write data WD specified by the write command WCMD. Then, the cache controller 123 stores write data WD in the cache 140 as write cache data WCD (B301).

The CPU 125 compares a write LBA range specified by the write command WCMD with the LBA range of the write cache data saved to the save area 112 (B302). The LBA range of the saved write cache data is indicated by the start LBA and end LBA (or the number of blocks) extracted from each of cache management records CMR1 to CMRn, for example, included in the saved management information written to the save area 112.

Then, based on the result of the comparison, the CPU 125 determines whether any LEA range overlaps the write range (B303). If the determination in B303 is Yes, the CPU 125 requests the cache controller 123 to update the saved write cache data in the overlapping range.

Then, the cache controller 123 cooperates with the DIF controller 122 in executing B304 as follows. First, the cache controller 123 extracts write data WDp in the overlapping range from write data WD. The cache controller 123 then allows the DIF controller 122 to overwrite the write cache data in the overlapping range in the save area 112 with write data WDp. In other words, the DIP controller 122 updates the write cache data in the overlapping range in the save area 112 to write data WDp.

Then, the cache controller 123 generates a cache management record CMR for the write cache data and stores the cache management record in the cache management table 127 (B305). B305 is also executed when the determination in B303 is No. When B305 is executed, the CPU 125 reports a status related to execution of the write commands WCMD to the host (B306), and ends the write command process.

The above-described write command process is based on the assumption that the write, to the user data area 113, of the write cache data saved to the save area 112 has not been completed. If the write, to the user data area 113, of the write cache data saved to the save area 112 has been completed, B305 is executed after B301, though this is not shown in a flowchart in FIG. 5.

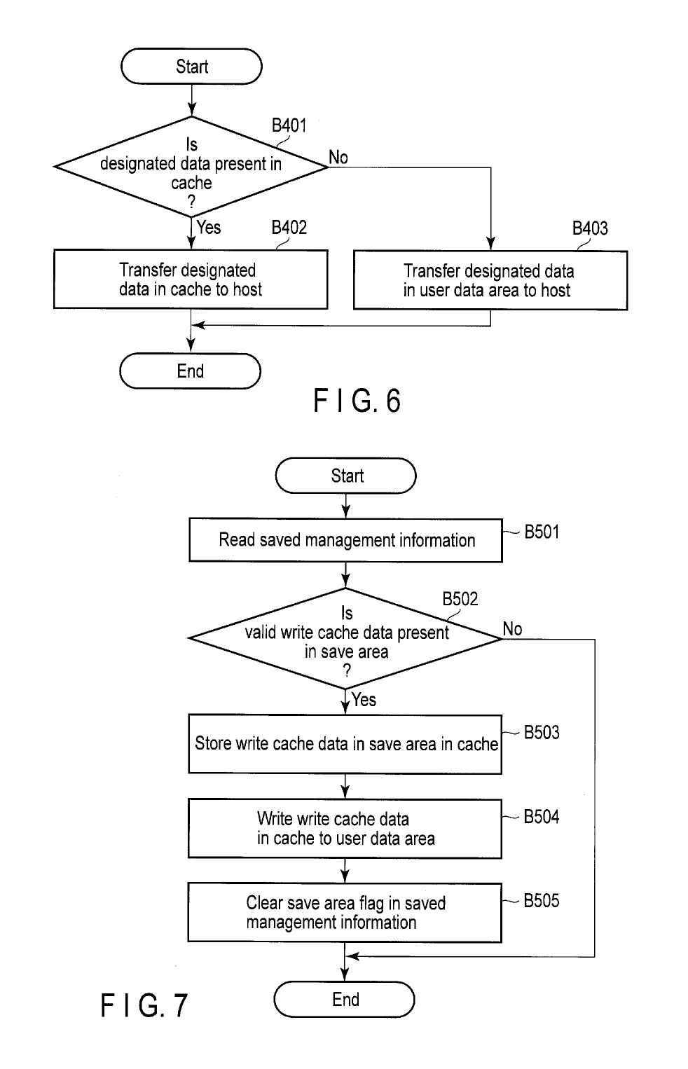

Now, a read command process in the embodiment will be described with reference to FIG. 6. FIG. 6 is a flowchart illustrating an exemplary procedure for the read command process. It is assumed that a read command RCMD from the host is executed by the CPU 125. That is, it is assumed that the HIF controller 121 receives the read command RCMD sent from the host to the HDD and passes the read command RCMD to the CPU 125.

In accordance with the read command RCMD, the CPU 125 executes the read command process as follows. First, the CPU 125 determines, based on the cache management table 127, whether data designated by the read command RCMD is present in the cache 140 (B401). If the determination in B401 is Yes, the CPU 125 instructs the cache controller 123 to read the designated data from the cache 140. Then, the cache controller 123 reads the designated data from the cache 140, and allows the HIF controller 121 to transfer the read data to the host (B402).

In contrast, when the determination in B401 is No, the CPU 125 requests the cache controller 123 to read the designated data from the disk 110. The cache controller 123 then cooperates with the DIF controller 122 in reading the designated data from the user data area 113 in the disk 110, and allows the HIF controller 121 to transfer the read data to the host (B403). The cache controller 123 also stores the read data in the cache 140. The CPU 125 stores a cache management record for the read data stored in the cache 140, in the cache management table 127.

It is assumed that power supplied to the HDD is suddenly shut down. It is assumed that, at this time, the write, to the user data area 113, of the write cache data saved to the save area 112 has not been completed. It is further assumed that the power is subsequently turned on. Then, in response to the power-on, a process accompanying power-on is started. The process accompanying power-on (more specifically, the process accompanying power-on for the write cache data saved to the save area 112) in the embodiment will be described with reference to a flowchart in FIG. 7. FIG. 7 is a flowchart illustrating an exemplary procedure for the process accompanying power-on.

First, the CPU 125 cooperates with the cache controller 123 and the DIF controller 122 in reading the saved management information 314 from the save area 112 in the disk 110 (B501). The CPU 125 then determines whether valid write cache data is present in the save area 112 based on whether the save area flag has been set in the read saved management information 314 (B502).

If the save area flag has been set in the saved management information 314, the CPU 125 determines that valid write cache data is present in the save area 112 (Yes in B502). In this case, CPU 125 requests the cache controller 123 to store the write cache data in the save area 112 into the cache 140.

Then the cache controller 123 cooperates with the DIF controller 122 in executing B503 as follows. First, the cache controller 123 allows the DIF controller 122 to sequentially read all of write cache data WCD1 to WCDn saved to the save area 112 based on the saved management information 314. The cache controller 123 then stores read write cache data WCD1 to WCDn in the cache 140.

On the other hand, the CPU 125 generates cache management records CMR1 to CMRn for read write cache data WCD1 to WCDn based on the cache management data 312 in the saved management information 314. The CPU 125 then stores generated cache management records CMR1 to CMRn in the cache management table 127.

Then, the cache controller 123 allows the DIF controller 122 to write all of write cache data WCD1 to WCDn stored in the cache 140 to the user data area 113 based on generated cache management records CMR1 to CMRn (B504). Cache management records CMR1 to CMRn are generated based on the cache management data 312 as described above. Therefore, B504 is equivalent to execution based on the cache management data 312. In B504, each time the write cache data is written to the user data area 113, the cache controller 123 clears the write cache flag in the corresponding cache management record.

When all of write cache data WCD1 to WCDn have been written to the user data area 113, the CPU 125 clears a save management flag in the saved management information 314 in the save area 112 (B505). The CPU 125 then ends the process accompanying power-on. In contrast, when the determination in B502 is No, the CPU 125 immediately ends the process accompanying power-on.

According to the embodiment, even when the power is shut down before the writing of all saved write cache data WCD1 to WCDn to the user data area 113 is completed, write cache data WCD1 to WCDn in the cache 140 and cache management records CMR1 to CMRn in the cache management table 127 can be restored based on the data in the save area 112. In other words, according to the embodiment, even when the HDD includes no backup power supply, the data present in the cache 140 and in the cache management table 127 immediately before power shut-down can be secured.

<Modification>

Now, a modification of the embodiment will be described. In the embodiment, upon writing write cache data WCDi to the user data area 113 in the write-back operation (B202 in FIG. 4), the CPU 125 clears only the write cache flag in cache management record CMRi (FIG. 4, B203). However, in the present modification, the CPU 125 clears not only the write cache flag in cache management record CMRi but also the write cache flag extracted from cache management record CMRi and included in the saved management information 314.

In the present modification, saved write cache data WCD1 to WCDn are written to the save area 112 in order of the corresponding command reception number. It is assumed that, in response to the writing of write cache data WCDi to the user data area 113 (B202), the CPU 125 clears the write cache flag extracted from cache management record CMRi and included in the saved management information 314. It is further assumed that, immediately after the clearage, the power is shut down. In other words, it is assumed that the power is shut down before write cache data WCDi+1, WCDi+2, . . . , and WCDn of the saved write cache data WCD1 to WCDn are written to the user data area 113.

In such a case, at the beginning of the process accompanying power-on, the CPU 125 in the modification references the saved management information 314 in the save area 112 starting with the first piece of the data. The CPU 125 then searches for a set write cache flag. In this case, the write cache flag extracted from cache management record CMRi+1 is detected first.

Then, in a process corresponding to B503 in FIG. 7, the cache controller 123 stores write cache data WCD1 to WCDn in the save area 112, in the cache 140. In a process corresponding to B504 in FIG. 7, the cache controller 123 allows the DIF controller 122 to write cache data WCDi+1, WCDi+2, . . . , WCDn to the user data area 113.

The present modification enables a reduction in the time needed for the process accompanying power-on compared to the above-described embodiments if the power is shut down before the writing of all saved write cache data WCD1 to WCDn to the user data area 113 is completed. However, the present modification results in the need of an extended time for the write-back process compared to the above-described embodiments.

At least one of the above-described embodiments enables a reduction in the time needed for the synchronize command process.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic disk device comprising:
a disk comprising a save area and a user data area;
a volatile memory comprising a cache area and a cache management area, the cache area being used to store, as write cache data, write data specified by a write command to be written to the user data area, the cache management area being used to store management records for the write cache data; and
a controller which writes write cache data indicated by the management record and not having been written to the user data area, to the save area in accordance with a synchronize command.

2. The magnetic disk device of claim 1, wherein the controller writes the write cache data saved to the save area to a regular location in the user data area specified by a write command corresponding to the saved write cache data, based on the management records for the saved write cache data.

3. The magnetic disk device of claim 2, wherein the controller invalidates the write cache data in the save area in response to completion of writing of all the saved write cache data to the user data area.

4. The magnetic disk device of claim 1, wherein the controller writes saved management information including flag data indicative of validity of the write cache data in the save area, starting with a leading position of the save area in accordance with the synchronize command, and writes the unwritten write cache data to the save area such that the unwritten write cache data succeeds the written saved management information.

5. The magnetic disk device of claim 4, wherein:
the saved management information includes cache management data corresponding to the management record for the write cache data not having written to the user data area; and
the controller writes the write cache data saved to the save area to the regular location in the user data area based on the cache management data in a first case where power supplied to the magnetic disk device is turned on and where the write cache data in the save area is valid, and changes status of the flag data in response to completion of the write in the first case.

6. The magnetic disk device of claim 5, wherein, in the first case, the controller stores the write cache data saved to the save area in the cache area and generates a new management record for the write cache data stored in the cache area based on the cache management data to store the generated management record in the cache management area.

7. The magnetic disk device of claim 1, wherein the controller performs overwriting when a write range specified by a first write command to be executed overlaps a write range specified by a write command corresponding to the first write cache data saved to the save area, wherein the overwriting comprises replacing cache data of overlapping range, which is included in the first write cache data saved to the save area with data of the overlapping range, which is included in write data specified by the first write command.

8. The magnetic disk device of claim 7, wherein the controller writes the write cache data saved to the save area to the regular location in the user data area specified by the write command corresponding to the saved write cache data based on the management record for the saved write cache data.

9. The magnetic disk device of claim 1, wherein the controller determines whether data designated by a read command is present in the cache area based on the management record, and reads the designated data from the cache area based on a result of the determination.

10. The magnetic disk device of claim 9, wherein the controller reads the designated data from the user data area when the designated data is not present in the cache area.

11. A method, in a magnetic disk device comprising a disk and a volatile memory, for executing a synchronize command, the disk comprising a save area and a user data area, the volatile memory comprising a cache area and a cache management area, the cache area being used to store, as write cache data, write data specified by a write command to be written to the user data area, the cache management area being used to store management records for the write cache data, the method comprising:
writing write cache data indicated by the management record and not having been written to the user data area, to the save area in accordance with a synchronize command; and
reporting a status related to execution of the synchronize command to an issuer of the synchronize command in response to completion of write, to the save area, of the write cache data not having been written to the user data area.

12. The method of claim 11, further comprising writing the write cache data saved to the save area to a regular location in the user data area specified by a write command corresponding to the saved write cache data, based on the management records for the saved write cache data.

13. The method of claim 12, further comprising invalidating the write cache data in the save area in response to completion of writing of all the saved write cache data to the user data area.

14. The method of claim 11, further comprising writing saved management information including flag data indicative of validity of the write cache data in the save area, starting with a leading position of the save area in accordance with the synchronize command, wherein writing the unwritten write cache data comprises writing the unwritten write cache data to the save area such that the unwritten write cache data succeeds the written saved management information.

15. The method of claim 14, wherein:
the saved management information includes cache management data corresponding to the management record for the write cache data not having written to the user data area; and
the method further comprises:
writing the write cache data saved to the save area to the regular location in the user data area based on the cache management data in a first case where power supplied to the magnetic disk device is turned on and where the write cache data in the save area is valid; and
changing status of the flag data in response to completion of the write in the first case.

16. The method of claim 15, further comprising:
in the first case, storing the write cache data saved to the save area in the cache area; and
generating a new management record for the write cache data stored in the cache area based on the cache management data to store the generated management record in the cache management area.

17. The method of claim 11, further comprising performing overwriting when a write range specified by a first write command to be executed overlaps a write range specified by a write command corresponding to the first write cache data saved to the save area, wherein the overwriting comprises replacing cache data of overlapping range, which is included in the first write cache data saved to the save area with data of the overlapping range, which is included in write data specified by the first write command.

18. The method of claim 17, further comprising writing the write cache data saved to the save area to the regular location in the user data area specified by the write command corresponding to the saved write cache data based on the management record for the saved write cache data.

19. The method of claim 11, further comprising:
determining whether data designated by a read command is present in the cache area based on the management record; and
reading the designated data from the cache area based on a result of the determination.

20. The method of claim 19, further comprising reading the designated data from the user data area when the designated data is not present in the cache area.
